(19) United States
(12) Patent Application Publication
(10) Pub. No.: US 2008/0315442 A1
(43) Pub. Date: Dec. 25, 2008

(54) Method and Apparatus for Replicating Microstructured Optical Masks

(75) Inventor: Armin Schwerdtner, Dresden (DE)

Correspondence Address: FOX ROTHSCHILD LLP, P O BOX 592, 112 NASSAU STREET, PRINCETON, NJ, 08542-0592, US

(73) Assignee: SEEREAL TECHNOLOGIES GMBH, Dresden (DE)

(21) Appl. No.: 11/574,772

(22) PCT Filed: Sep. 7, 2005
(86) PCT No.: PCT/EP05/09590

§ 371 Date: Mar. 6, 2007

(30) Foreign Application Priority Data
Sep. 8, 2004 (DE) 10 2004 043 385.2

(51) Int. Cl. B29D 11/00

(52) U.S. Cl. 264/1.7; 425/116

(57) ABSTRACT

The invention relates to a method and an apparatus for replicating planar, thin-layered, and microstructured flat lens system and optical mask (LM) that are provided with such microstructured lens system which are hardened from a highly viscous transparent fluid on a supporting substrate plate (TP). The fluid is introduced between a plate-shaped master plate (M) and a movable supporting substrate plate and remains joined to said substrate plate after hardening. The inventive method is carried out in a non-rotational manner while the molding space is not delimited by sidewalls or similar in the direction of expansion of the fluid. The inventive flat lens systems or optical masks are embodied as lenticular arrays, field lenses, or Fresnel lenses. The final shape of the mask is homogeneous, has a geometrically accurate layer thickness, and is free from air pockets. The inventive method and apparatus allow for controlled replication at great geometrical accuracy and extremely good optical quality.

Method and device for the replication of finely-structured flat optical elements and optical masks with finely-structure optical elements.

The present invention relates to a method and device for the replication of flat, finely-structured, thin-film optical elements and optical masks with so-structured optical elements, said optical elements being made of a transparent, highly viscous or viscous fluid which hardens on a carrier plate or substrate, where the fluid is injected into a cavity between a master plate (the mould) and the movable carrier plate and adheres to the carrier plate after hardening.

The method makes use of an irrotational flow. The mould cavity is not constrained by side walls etc. in the direction of flow of the fluid to be hardened. The master plate is used as the original in the replication process. It is situated in an irrotational and horizontal position. The required volume of the fluid to be hardened is injected into the mould cavity, which is formed between the two plates, without a controllable injection valve.

The term “optical mask” will be used in this document as a generic term for a mask or flat optical element. Optical masks include flat elements with various optical surface structures, such as lenticular arrays, lens array plates or matrix structures. They are usually of rectangular shape and exhibit a matrix, cylindrical or spherical structure. Cylindrical masks are in particular lenticular arrays, e.g. with a multitude of contiguous lenticules in the form of cylindrical lenses in parallel arrangement. A cylindrical optical mask can also be a cylindrical Fresnel lens or a prism mask or a similar element. Spherical optical masks are, for example, spherical Fresnel lenses. A flat optical element is also characterised by an optical surface structure. However, the carrier plate here is a light-emitting or transmissive optical element such as a light modulator, e.g. a LC display, an image matrix or a spatial light modulator.

These masks typically have the size of a monitor or display screen and are very thin, i.e. they have a thickness of a few tenths of a millimetre. The depth of the optical structures of the optical mask is usually smaller than 200 micrometers. Structured surfaces for optical applications require great shape precision and extremely low roughness, i.e. in the magnitude of a few nanometres.

Great demands are made on the optical masks used in complex optical systems, such as autostereoscopic displays. Autostereoscopic displays require left and right image information to be separated spatially with the help of an optical projection system. In order to be able to view image information stereoscopically, image contents intended for one of the viewers' eyes must be delivered to that one eye without cross-talking to other eyes. The corresponding means are known as image separation devices, said devices being for example realised in the form of an illumination matrix and a focusing matrix. These and other essential elements of autostereoscopic displays are typically realised in the form of lenticular arrays, or combined with lenticular arrays, which makes lenticular arrays very important design elements.

Lenticular arrays are usually very finely structured and exhibit a very small pitch. In order to achieve the optical objectives, the lens size, i.e. the pitch of the lenticules is often matched with the pitch of an image matrix. The term “image matrix” is used in this document as a generic term for light-emitting or transmissive light modulators. If for example a lenticule of the lenticular array is assigned to only a few pixel columns of the image matrix, several important objectives will arise when miniaturisation of the pixels of the image matrix occurs. In the context of progressive miniaturisation of the pixels, which are used as a reference to set the size of the lenticules, there is the risk that the limits of optical feasibility, or at least the limits of cost-efficient and reliable production of the lenticular arrays, will be reached and exceeded.

Manufacturing a lenticular array with lenticules which have the size of few display pixels is very difficult; and manufacturing a lenticular array with lenticules which have the size of only one display pixel is probably already outside the scope of technological feasibility, considering the display resolutions commercially available today.

### PRIOR ART

A number of methods are known, and have partly been known for a long time, for the replication of flat optical elements. One technique of filling a mould cavity with a fluid is described by the injection filling method. According to that method, the fluid flows through an injection opening into the mould cavity at ambient pressure. In contrast, according to the pressure filling method, the fluid is injected into the mould cavity at usually very high pressure. With simple methods the fluid is injected into the mould cavity until excess fluid runs off at one or several escape openings.

EP 0 141 531 B1, meanwhile expired, discloses such a method for filling the mould cavity. Liquid resin is injected through an injection opening into a walled mould cavity until sensors detect the resin to have reached a run-off opening, which is situated at a distance from the injection opening, or until position detectors determine the resin to have sufficiently filled also the marginal sections of the mould cavity.

EP 0 688 649 B1 describes the filling of a confined mould cavity with a fluid material through an opening. By applying a force directed outward (a transverse force) the fluid material is taken away from the injection opening. The force for injecting the fluid, i.e. gravitation or pressure, and the transverse force can be applied independently of each other. The transverse force is described in the cited document as a centrifugal force, the description thus also embraces rotational moulding methods.

According to another aspect of that invention, the fluid is injected into the mould cavity through an injection opening while excess amounts of the fluid can escape the mould cavity through a run-off opening, whereby the filling level in the mould cavity is detected and controlled with the help of sensing elements.

WO 99/30 886 describes the use of seals or membranes which are permeable to air, but impermeable to the fluid. During injection, the mould cavity is evacuated through such seals or membranes. After filling the mould cavity, the cell openings in the sealing material are closed and the fluid is hardened. However, this method appears to be unfeasible for mass production.

EP 0 490 580 B1, meanwhile expired, describes a method for laminating glass sheets and making laminated glass articles. During the process the glass plates are positioned horizontally or can be slightly inclined temporarily. According to that method, resin is injected between two glass plates which are to be laminated and which are disposed at a distance. First, spacer means are attached to the glass plates. These spacer means are disposed along the edges of the glass plates, and they are permeable to air but impermeable to a fluid. Secondly, after having positioned the plates, a certain amount of resin is injected through an injection tube into the cavity between the glass plates, whereby the resin makes contact with the inner faces of the two glass plates, and the injection is controlled such that the fluid spreads between the plates in a defined manner. Thirdly, the cavity between the glass plates is filled with the remaining amount of the fluid, whereby the air displaced by the injected resin can escape through the above-mentioned air-permeable spacer means. Finally, the resin is hardened and forms a firm layer between the glass plates. The resin is preferably injected in the central area of the glass plates. The resin is injected through an injection tube into the cavity between the glass plates, and an opening is provided in the circumferential, air-permeable spacer means for the injection tube. In particular, the spacer means are made of foamed adhesive tape strips which exhibit an open porous structure.

The method also includes the step that the glass plates are pressed while the resin is injected in order to support the injection of the resin into the cavity between the two glass plates. The plates can be pressed by placing them into an environment which has a slightly positive pressure, whereby in the evacuation step the air can escape through the spacer means which are permeable to air but impermeable to the fluid.

U.S. Pat. No. 6,203,304 B1 describes a method and apparatus for filling a cell cavity between a first substrate and a second substrate with a cell filling liquid. The method describes several evacuation cavities which are disposed at the outer surface of the two substrates The evacuation cavities are communicating with sub-cavities in the mould cavity. The evacuation cavities aim to minimise the overpressure in the mould during the filling process.

DE 36 43 765 A1 discloses a process for the production of a plastic layer between two glass sheets and an apparatus for carrying out the process. A liquid plastic material is injected into a cavity between the glass sheets, and the glass sheets may be disposed in parallel or at an angle to each other during the filling process. Then, the edges of the glass sheets are aligned and sealed. In a subsequent step, the two glass sheets are pressed against each other from the outside, whereby during hardening of the plastic material a high pressure is exerted by one or several rotating pressure rollers which are traversed along the glass plates.

U.S. Pat. No. 4,170,616, Method of fabrication of a Fresnel lens, 1978, describes a method for the irrotational replication of flat Fresnel lenses, which involves a closed, vacuum-tight mould cavity formed between a vertically or horizontally disposed master plate (plastic mould), which is a negative of the Fresnel structures to be fabricated, and a plane substrate surface. Air is evacuated from this chamber and then a hardening fluid is admitted to this chamber, said fluid being sucked in owing to the low pressure inside the chamber.

DE 22 55 923 A1 discloses a method for casting optical lenses, where a synthetic resin is injected into a cavity formed by an upper and a lower mould and hardened. The replication device is fitted with a gap seal. The moulds are fixed to each other by way of mechanical guiding means, whereby the length of said guiding means determines the distance between the two moulds and thus the thickness of the optical element to be fabricated.

U.S. Pat. No. 5,202,793, Three dimensional image display apparatus, mentions in the description of FIG. 11 a device consisting of a vacuum frame and ultraviolet light source and infrared heater assembly. A sandwich is made of upper and lower plastic film sheets which have curable plastic sandwiched between them. This assembly, along with a rigid lower mould and a thin UV transmitting upper mould are placed in a vacuum frame. Vacuum is applied, causing the sandwich element to be forced into the indentations in upper and lower moulds and finally to be cured.

JP 63307909 describes a typical rotational method of fabricating or forming resin discs which particularly aims to eliminate the generation of air bubbles. The resin is injected through a dosing device, a so-called dispenser, into the centre of a fast rotating mould and the resin spreads due to the centrifugal force and covers the mould. This method is used to fabricate high-quality optical discs and round masks. However, the dimensions of the discs made by this process are limited.

Rotational methods are very robust and reliable to make small elements, but those methods cannot be applied sensibly in the production of the desired rectangular optical masks for monitors which measure 20″ or more in diagonal.

The mould filling methods discussed above, i.e. the method which involves two openings and the method of fluid-impermeable sealing, bear the disadvantage that the walls of the mould tend to be bent by the high forces exerted on them, in particular with large-area thin-walled moulds. If a vacuum is applied to a second opening, the risk of deformation to the walls of the mould will even increase, so that an inaccurately formed, defective optical element may be produced.

The mentioned finely-structured thin-film masks must be made in compliance with highest quality standards. A deficient optical mask causes for example a pixel error which is permanently visible on the display. Each defective pixel, as it is for example caused by an air inclusion, can only in exceptional cases be repaired, so that the imperfect optical element needs to be scrapped.

The fluid to be hardened, i.e. the resin, does not usually form a significant expense factor. In contrast, the highly precise master plate represents the core element of the replication device and is customarily very costly. The excess amount of resin which spreads between the moulds beyond the target dimensions of the mask to be fabricated hardens together with the optical mask and adheres to the master plate. It must be removed from the master plate in a time-consuming cleaning process. This process-related downtime reduces the availability of the entire replication device. The master plate also suffers great wear during such cleaning work. Moreover, any additional manipulation poses the risk of damage, so that the life of the costly master plate may be significantly shortened.

The cast optical mask remains inside the apparatus until the fluid is sufficiently hardened. However, it is desirable to reduce the cycle time of the replication process, in particular the time needed for applying the fluid and for forming the mask.

The simplicity of the replication method and device should go along with easy manipulability in order to ensure high system availability and high process reliability.

As mentioned above, the optical masks are very thin, they preferably have a thickness of less than 200 micrometers. It is obvious before this background that the permissible manufacturing tolerances are extremely small and the demands made on the shape and dimensional stability are very great. Such a great dimensional accuracy in the vertical direction will be achieved if the substrate plate is successfully prevented from bending during the forming process.

In addition to the other aforementioned objects, both the replication method and the corresponding device shall ensure the described finely-structured thin-film optical masks to be made reliably and economically. The final product must exhibit great shape and dimensional stability and have a high optical quality.

### SUMMARY OF THE INVENTION

The method can be classified as an irrotational moulding method. The replication process is preferably carried out in a horizontal position. The method is used to replicate finely-structured flat optical elements and optical masks, in particular for use in autostereoscopic displays, said elements or masks being made of a transparent viscous fluid, such as a resin, which is hardened after moulding.

The optical masks are usually of rectangular shape and exhibit a cylindrical or spherical structure. Cylindrical masks are in particular lenticular arrays, e.g. with a multitude of contiguous lenticules in the form of cylindrical lenses in parallel arrangement. A cylindrical optical mask can also be a cylindrical Fresnel lens or a prism mask or a similar element. Spherical optical masks are, for example, spherical Fresnel lenses.

These masks typically have the size of a monitor or display screen and are very thin, i.e. they have a thickness of a few tenths of a millimetre. The thickness of the optical mask is preferably less than 200 micrometers.

The novel replication device consists of a mould cavity which includes a flat, horizontally disposed master plate. The master plate has in its centre a structured replication section, which represents the negative in the replication process, and a circumferential planar marginal section. The replication section is detachably fixed to the master plate, preferably by way of low pressure. A sealing ring surrounds this plate. A movable carrier plate rests on this sealing ring and encloses the mould cavity in an air-tight manner.

According to this invention, the replication device contains means for detecting the distance between these plates. This invention is based on the idea that the distance between the plates can be controlled by varying the low pressure in the mould cavity.

In a continuation of this invention, the distance between the plates can alternatively be controlled through variable spacer means.

The inventive method comprises the main stages of initial dispensing and moulding. In the following, these steps will be described in detail below.

A first main stage (a) in this process is called initial dispensing. It includes:
(a1) Initial point: application of the fluid to be hardened to one or several small areas of the carrier plate as initial points. A single initial point is preferably situated in the centre of the carrier plate.
(a2) Tracking: application of several tracks of the fluid onto the master plate. The tracks preferably run from the centre of the replication section towards the marginal section of the master plate, or between the counterpoints (explained below). The tracks are preferably contiguous and run in the radial direction and/or are formed like a crescent.
(a3) Dispensing: application of the required amount of the fluid onto the master plate. Thereby, a one-piece initial fluid section is moulded. Vertical peaks will be formed in this section which represents counterpoints, where a counterpoint on the master plate is always congruent with an initial point on the carrier plate.

The steps of the initial dispensing stage (a) are preferably executed in an automated manner, e.g. with the help of a dispenser and manipulation equipment; they can thus be performed simultaneously or in an overlapped mode.

The second main stage (b) is called moulding. It includes:
(b1) Initial contact: placing the horizontally-positioned carrier plate on to the master plate, whereby carrier plate and master plate make initial contact at the initial points and counterpoints, and whereby the carrier plate rests on the sealing ring (D) so as to seal the mould cavity (R) in an air-tight manner.
(b2) Controlled moulding: application of low pressure to the mould cavity, whereby the carrier plate is drawn near the master plate in a controlled manner so that the fluid of the initial fluid section is continuously distributed starting at the initial points and counterpoints and along the tracks and completely fills the cavity formed between the plates as defined by the replication section of the master plate, and whereby the low pressure in the mould cavity and variable spacer means between the plates, if any, are used as controllable process parameters.

The steps of the moulding stage (b) are preferably executed in an automated manner, e.g. with the help of sensors and a programmable control of the process parameters.

The inventive method is based on the idea that the initial form of the fluid, i.e. the initial fluid section, is transformed into the desired rectangular shape of the mask with the help of the tracks.

A first process condition is that there must be no inclusions of air in the optical mask. A second requirement is that the final shape of the mask is formed in a horizontal position and without dimensional shortfall, but also exceeding the desired dimensions by as little as possible.

According to this invention, these objects are achieved with the help of the tracks. Here, a track is preferably a radial and/or crescent-shaped, one-piece track of the fluid. In a variant of this invention, the tracks may also form longish areas. These longish areas are selected such as to avoid air inclusions while the fluid flows though the cavity.

The multiple tracks preferably run from the initial fluid section towards the marginal section of the master plate. The tracks are preferably applied to run in the spreading direction of the fluid during the flowing process, i.e. they form a trajectory in the flowing direction. A deviation from the ideal trajectory may aim at specifically controlling the spreading direction of the fluid and to facilitate the progress from one groove in the mould to an adjacent groove.

There is always a transitional area of reduced vertical dimension between the channels in the master plate. The fluid thus tends to flow along the channel rather than to progress into the adjacent channel. In this respect, this invention is based on the idea that the tracks can be used to create “bridges” between adjacent channels and to initiate progress of the fluid from one channel to an adjacent channel.

In the dispensing step (a3), the required quantity of the fluid is applied on to the master plate, and the initial fluid section is formed there. According to the invention, in the fluid section one or several vertical peaks, or counterpoints, are formed due to the viscosity of the fluid. According to the invention, these points are congruent with the corresponding initial points on the carrier plate.

In a simple embodiment, the initial fluid section is a one-piece section of round, elliptic or almost oval shape. This basic shape may be extended by pockets facing the corners of the replication section. The fluid section may also be of a radiating or meandering form, but always contains at least one counterpoint. A single counterpoint is preferably situated in the centre of the replication section of the master plate. Reference is made in this respect to the schematic diagrams in the Figures.

The structure of the optical mask as the final product, e.g. a cylindrical lenticular array or a spherical field lens, has a major influence from the form of the initial fluid section, the run of the tracks and the position of the counterpoints.

In the second stage of the process, the moulding stage (b), the idea of the invention is continued. In the initial contact step (b1), the horizontally-placed carrier plate is positioned, whereby the counterpoints on the master plate and the initial points on the carrier plate make initial contact. It may become necessary to build up the counterpoints of the initial fluid section immediately before the initial contact of the plates. This may be realised by adding a small quantity of fluid to the respective positions in the initial fluid section. Thanks to the defined initial contact of the fluids at these initial points according to this invention undesired air inclusions are prevented from being formed during this process step. At the same time, the carrier plate rests on the sealing ring and encloses the mould cavity in an air-tight manner.

In the subsequent second step, the controlled moulding step (b2), a low pressure is applied to the mould cavity, thereby drawing the carrier plate near the master plate in a controlled manner. Now, the fluid spreads continuously starting at the originally contacting initial fluid section and along the tracks.

According to the invention, the low pressure in the mould cavity and the variable spacer means, if such means are additionally used, are employed as controllable process parameters. According to the invention, these controllable parameters induce the fluid to spread while the bending of the carrier plate is maintained within the required tolerance range. These parameters are preferably programme-controlled.

The variable and controllable spacer means, which may be used in addition to the low pressure, are mechanical elements, such as worm gears. Other forms are for example pneumatic, hydraulic or, particularly preferred, piezo-electric elements. In a simple embodiment, the controllable spacer means have the form of a variable vertical resilience of the sealing ring, said sealing ring may thereby consist of several separately controllable segments.

According to the invention, two effects are eliminated by the low pressure in the mould cavity. First, the low pressure in the mould cavity induces the plates to be drawn closer to each other so that the fluid spreads. Secondly, a pull is applied to the fluid section which also causes the fluid to spread. According to the invention, these forces can be superimposed so that only a low vertical force is exerted on the carried plate while the plates are drawn closer in a controlled manner. Consequently, the carrier plate only bends to a very little extent during this process, it remains plane within the required tolerance range until the fluid is hardened, thus ensuring the desired form stability of the final product. The controlled moulding step may be supported if necessary by the variable spacer means as further controllable process variables.

According to a variant of the process, the fluid is induced to vibrate in the mould cavity. This vibration exciter is preferably an ultrasonic exciter realised in the form of a power sonotrode. The micro-vibrations sustainedly accelerate the spreading of the fluid, because the progress of the fluid from channel to channel is supported. Moreover, stress in the material is minimised during hardening. The final product is thus quasi stress-relieved.

According to the inventive method, the fluid completely fills the cavity between the plates as defined by the replication section of the master plate. The final cast of the mask is homogeneous, has stable dimensions and shape, and is free of air inclusions. The actual horizontal dimension of the final cast is only slightly larger than the required mask, which corresponds with the replication section provided on the master plate.

The method and device according to the invention allow the masks to be replicated in a reliable process, at great form stability and in compliance with high quality standards. Thanks to the fact that the desired dimensions are only slightly exceeded, only little time and labour is needed for cleaning after a replication process, which contributes to a great system availability.

### SHORT DESCRIPTION OF FIGURES

Other embodiments will be explained in detail in conjunction with the accompanying drawings.

FIG. 1a and 1b show a projection and front view of the novel replication device.

FIG. 2a shows a detail of the front view of the replication device.

FIG. 2b is a perspective view showing a detail of the mould cavity of the replication device.

FIGS. 3a to 3d are details of the preferred variants of the initial fluid sections, counterpoints and tracks.

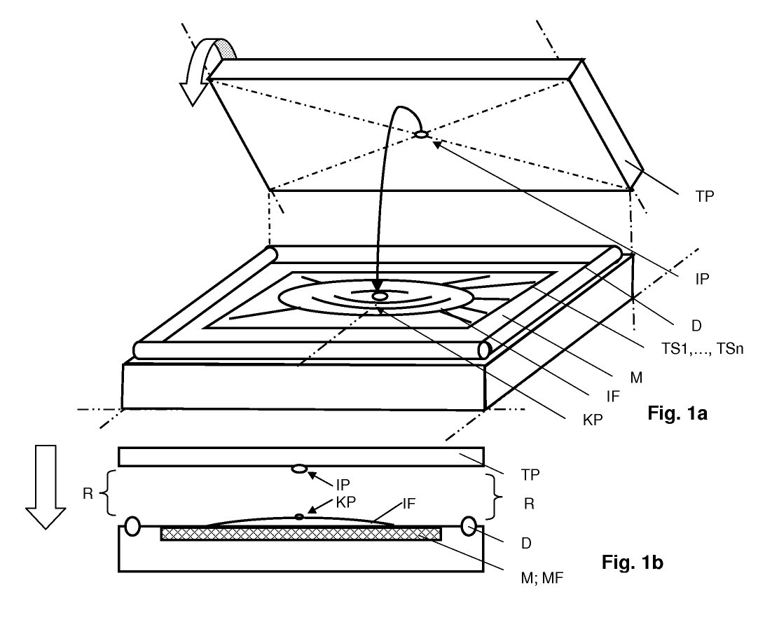

FIG. 1a and 1b show a perspective and front view of the device for the replication of flat, rectangular, finely-structured, thin-film optical masks. The mould cavity R of the replication device contains a master plate M, a circumferential sealing ring D and a movable carrier plate TP. The master plate M has a structured replication section MF, which represents the negative in the replication process, and a circumferential planar marginal section MR.

The initial dispensing process stage (a) is substantially completed in these drawings. In the initial point step (a1), a single initial point IP of the fluid to be hardened was applied on to the carrier plate TP. Here, this point IP is situated in the centre of the carrier plate TP.

In the tracking step (a2), multiple tracks T1, T2, . . . of the fluid material were applied on to the master plate M. Here, these tracks run from the centre of the master plate towards the margin of the replication section MF on the master plate. Here, the tracks are contiguous.

In the dispensing step (a3), the required quantity of the fluid material was applied on to the master plate M, here in the centre of the plate, and a one-piece initial fluid section IF was created, whereby its vertical peak forms a counterpoint KP. As shown in the Figure, the counterpoint KP is congruent with the initial point IP of the carrier plate TP.

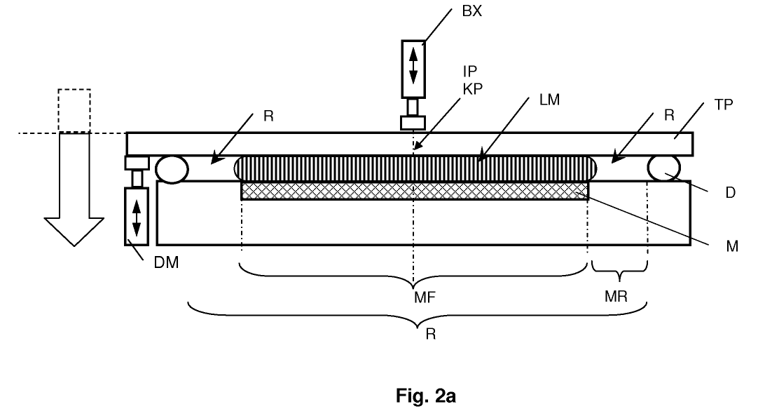

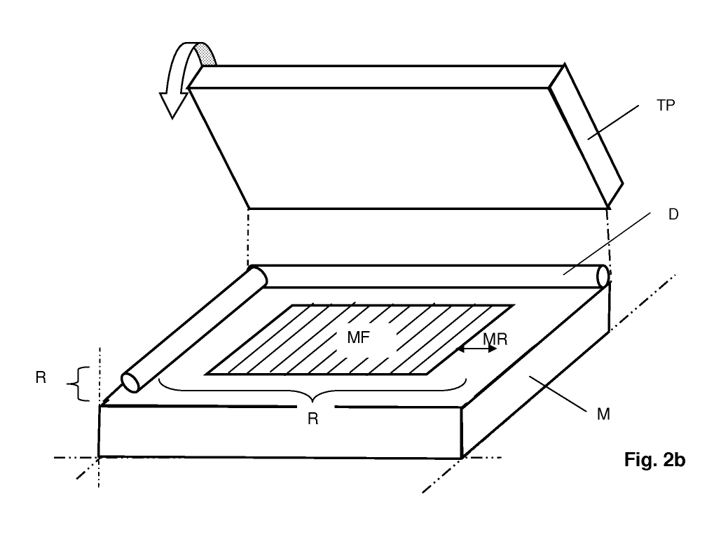

FIG. 2a shows a replication device, similar to the one shown in FIG. 1, but after completion of the moulding stage (b). In the initial contact step (b1), the horizontally-positioned carrier plate TP was placed on to the master plate M such that the counterpoint KP of the master plate M and the initial point IP of the carrier plate TP make initial contact, as was already seen in FIG. 1. The variable spacer means, here on the right-hand side, are implemented in the form of a sealing ring D in this embodiment. The sealing ring D exhibits a variable vertical resilience.

In the controlled moulding step (b2), low pressure is applied to the mould cavity R so that the carrier plate TP is continuously drawn near the master plate M and the fluid material continuously spreads along the tracks T1, T2, . . . , starting at the initial point IP and the counterpoint KP in the initial fluid section IF. The fluid completely fills the cavity between the plates as defined by the replication section MF of the master plate M. As required, the fluid only spreads little beyond that replication section MF of the master plate so that the actual horizontal dimension of the optical mask LM as the final product only slightly exceeds the replication section MF. A controllable heating or cooling unit, not shown, maintains a constant temperature of the fluid material in the replication device and in particular in the mould cavity.

Thanks to the low pressure and the variable spacer means DM as controllable process parameters, the carrier plate TP only insignificantly bends during this process step, stays plane and maintains a stable form. The optical mask LM thus fulfils the form stability requirements, in particular as regards the vertical tolerance limits.

In the Figure, another variant of the variable spacer means DM is shown schematically on the left-hand side of the replication device. In this variant, the spacer means DM are provided in the form of piezo-electric elements. These elements allow the distance between the plates to be controlled with extraordinary precision.

The above-mentioned variants of the spacer means DM, that is the sealing ring D with variable resilience (right) and the variable spacer means DM (left), are also preferably employed in the process step of removing the final product from the mould. In this step, the optical mask LM is detached from the master plate M with the help of the spacer means DM. For example, the sealing ring D is inflated until the carrier plate TP with the optical mask LM separates from the replication section MR of the master plate M.

This Figure shows a bending device BX, which allows to temporarily bend the carrier plate TP in the region around the initial point IP towards the master plate M, in particular during the initial contact step (b1), in order to support and to ensure proper initial contact of the plates at the initial point/counterpoint.

FIG. 2b is a perspective view showing schematically the mould cavity R of the replication device. The master plate M is positioned horizontally and consists of the replication section MF (hatched), which represents the final shape of the optical mask LM, and the coplanar marginal section MR, which surrounds the replication section MF. Here, the master plate M represents the base of the mould cavity R. A sealing ring D rests on the master plate and surrounds the marginal section MR of the master plate M. Only the left-hand side and rear segments of the sealing ring are shown in the Figure to maintain clarity. The sealing ring D at the same time represents the side walls of the mould cavity R. Finally, when the movable carrier plate TP is laid on to the sealing ring, the mould cavity R is confined. In a preferred embodiment of the invention, the replication mask MF is a movable plate which is for example fixed to the master plate M by way of low pressure. The representation of further spacer means will be omitted.

Another possible variant of the replication device is characterised by an inverse arrangement of master plate and carrier plate, i.e. the replication device described above is mirrored horizontally. Further, the carrier plate may be disposed in a fixed position while the master plate, or in particular the replication section of the master plate, is movable.

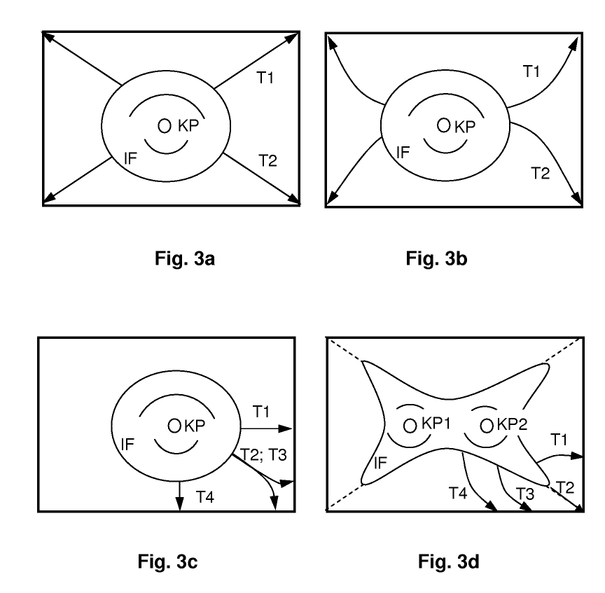

FIGS. 3a to 3d are schematic diagrams which illustrate the formation of the initial fluid section IP and the tracks T1, T2, . . . on the master plate M. More specifically, the Figures always show a top view of the replication section MF of the master plate M. In the dispensing step (a3), the required quantity of the fluid material is applied on to the master plate and a one-piece initial fluid section IF is created, whereby its vertical peak forms the counterpoint KP. The more complex tracks T1, T2, . . . are shown in detail only in the respective bottom left parts of the replication sections MF in the form of arrows. In these examples, the optical mask to be formed is a lenticular array with lenticules disposed in the vertical direction.

FIG. 3a shows the most simple form. The initial fluid section IF is almost oval, the tracks T1, T2, . . . run outward along the diagonal lines, and the counterpoint KP is situated in the centre of the replication section MF. FIG. 3b shows curved tracks T1 and T2, which are bent like a brachistochrone towards the marginal section. FIG. 3c shows ramified tracks T2 and T3. FIG. 3d shows an initial fluid section IF with pockets facing the corners of the replication section MF. The section has two counterpoints KP1 and KP2, and the tracks T1 to T3 are trajectories along the spreading direction of the fluid.

1. Method for the irrotational replication of finely-structured flat optical elements and optical masks with finely-structured optical elements, where a hardening transparent viscous fluid is injected into a mould cavity of a replication device, said mould cavity being formed between a horizontally-positioned master plate, which includes a replication section with a structure to be replicated and a planar marginal section, and a carrier plate which rests on a sealing ring which is disposed in the marginal section of the master plate and which confines the mould cavity in an air-tight manner, said method comprising the following steps:
(a1) Application of the fluid on to one or several small areas of the carrier plate as initial points of the fluid to be hardened;
(a2) Application of several tracks of the fluid on to the master plate which are formed in the radial direction and/or are formed like a crescent;
(a3) Application of a quantity of the fluid on to the master plate and forming of a one-piece initial fluid section, thereby forming one or several vertical peaks as counterpoints, said counterpoints being congruent with the corresponding initial points on the carrier plate;
(b1) Placing the carrier plate on to the assembly of the master plate and sealing ring, whereby the carrier plate is positioned horizontally such that the initial points and corresponding counterpoints make contact;
(b2) Application of low pressure to the mould cavity, whereby the carrier plate is drawn near the master plate in a controlled manner so that the fluid is continuously distributed starting at the initial points and counterpoints of the initial fluid section and completely fills the mould cavity above the replication section of the master plate, and whereby the low pressure determines the distance between the carrier plate and the master plate and completely fills the cavity between the plates as defined by the replication section of the master plate, whereby the low pressure is used as controllable process parameter.

2. Method according to claim 1, where the placing of the carrier plate on to the master plate is controlled through the low pressure in the mould cavity and controllable spacer means which determine the distance between the plates.

3. Method according to claim 1, where in a first process step (a1) an initial point is situated in the point of intersection of the diagonal lines of the carrier plate.

4. Method according to claim 3, where several tracks of the fluid applied on to the master plate run about in the spreading direction of the fluid.

5. Method according to claim 1, characterised in that several tracks of the fluid applied on to the master plate run from the centre towards the marginal section of the master plate.

6. Method according to claim 4, where the initial fluid section applied on to the master plate is a round or elliptic one-piece section.

7. Method according to claim 4, characterised in that the initial fluid section applied on to the master plate is radial and/or crescent-shaped and contiguous.

8. Method according to claim 6, where the initial fluid section applied on to the master plate is of a meandering form.

9. Method according to claim 6, where the initial fluid section applied on to the master plate exhibits pockets which face the corners of the replication section of the master plate.

10. Method according to claim 6, where a counterpoint formed in the initial fluid section applied on to the master plate is situated in the centre of the replication section of the master plate.

11. Method according to claim 1, where the tracks are ramified.

12. Method according to claim 1, where the outside surface of the carrier plate is detachably connected with a reinforcing backup plate.

13. Method according to claim 12, where the carrier plate is detachably connected with a reinforcing backup plate by way of low pressure.

14. Method according to claim 1, where in the process step (b1) a bending device depresses the carrier plate about where an initial point is situated, so that it bends towards the master plate.

15. Method according to claim 1, where the counterpoints in the initial fluid section are additionally built up between the process steps (a3) and (b1).

16. Method according to claim 1, where the optical mask has a spherical or cylindrical structure.

17. Method according to claim 1, where the steps (a1) to (a3) are performed simultaneously or in an overlapped mode.

18. Replication device for the irrotational replication of finely-structured, flat optical elements and optical masks with so-structured optical elements, said device consisting of a horizontally-positioned master plate, including a replication section with the structure to be replicated and a planar marginal section, a sealing ring disposed on said marginal section, a carrier plate, which detachably sits on the master plate and sealing ring assembly such that the space between master plate and the carrier plate together with the sealing ring forms a mould cavity, said mould cavity being sealed in an air-tight manner, and the device being adopted to
generate a controllable low pressure in the mould cavity,
detect the distance between the master plate and carrier plate, and
controls the low pressure in the mould cavity in order to set a desired distance between the master plate and the carrier plate.

19. Replication device according to claim 18, where the distance between the carrier plate and the master plate can be controlled with the help of variable spacer means.

20. Replication device according to claim 19, where the controllable spacer means are mechanical, pneumatic or hydraulic elements.

21. Replication device according to claim 19, where the controllable spacer means are piezo-electric elements.

22. Replication device according to claim 19, where the sealing ring for several segments of the sealing ring show a variable, controllable vertical resilience.

23. Replication device according to claim 18, which includes a controllable heating and/or cooling unit.

24. Replication device according to claim 18, where vibration exciters induce vibration of the fluid injected into the mould cavity.

25. Replication device according to claim 24, where vibration exciters induce vibration of the fluid injected into the mould cavity with the help of ultrasonic waves.

26. Replication device according to claim 18, which includes a bending device which is disposed on the carrier plate and which depresses the carrier plate vertically towards the master plate.
